(19) United States
(12) Patent Application Publication
(10) Pub. No.: US 2026/0049691 A1
(43) Pub. Date: Feb. 19, 2026

(54) STORAGE CONTAINER

(71) Applicant: LINDE GMBH, Pullach (DE)

(72) Inventors: Manfred SCHÖNBERGER, Pullach (DE); Florian EHEGARTNER, Pullach (DE); Christian Michael HERWERTH, Pullach (DE)

(21) Appl. No.: 19/099,629

(22) PCT Filed: Jul. 26, 2023
(86) PCT No.: PCT/EP2023/025349

§ 371 Date: Jan. 29, 2025

(30) Foreign Application Priority Data
Aug. 3, 2022 (DE) 10 2022 002 803.4

(51) Int. Cl. F17C 1/14; F17C 13/00

(52) U.S. Cl. CPC F17C 1/14; F17C 13/001; F17C 2201/035; F17C 2203/012; F17C 2203/0391; F17C 2203/0629; F17C 2203/0639; F17C 2203/0646; F17C 2203/0648; F17C 2203/0663; F17C 2203/0678; F17C 2221/012

(57) ABSTRACT

A storage container for storing a cryogen, comprising an inner container for receiving the cryogen and an outer container in which the inner container is accommodated, wherein the outer container has reinforcing rings for reinforcing the outer container and the outer container has a support element which is made of a composite material and of which at least some portions are arranged within a gap between two neighboring reinforcing rings, in order to support the reinforcing rings.

The invention relates to a storage container for storing a cryogen.

The applicant is aware of in-house double-walled storage containers for liquid hydrogen, which have an outer container and an inner container arranged within the outer container for receiving the liquid hydrogen. A gap provided between the inner container and the outer container is subjected to a vacuum. The gap can be at least partially filled with an insulating material. In order to reinforce the outer container, it is possible to provide reinforcing rings arranged spaced apart from one another along a center axis of the storage container. However, these reinforcing rings lead to an increase in the empty weight of the storage container and an increase in the installation space of the storage container. This must be improved.

Against this background, the object of the present invention is to provide an improved storage container.

Accordingly, a storage container for storing a cryogen is proposed. The storage container comprises an inner container for receiving the cryogen and an outer container in which the inner container is accommodated, wherein the outer container has reinforcing rings for reinforcing the outer container, and the outer container has a support element which is made of a composite material of at which at least some portions are arranged within a gap between two neighboring reinforcing rings in order to support the reinforcing rings.

Due to the fact that a support element is provided which supports the reinforcing rings, it is possible to increase the distance between the reinforcing rings and/or to make the reinforcing rings smaller in comparison to a storage container without such a support element, in particular up to the limiting case of no reinforcing rings. This makes it possible to reduce the empty weight of the storage container. It is also possible to reduce the installation space of the storage container. At the same time, the installation space of the inner container can be increased.

The storage container is also particularly suitable for transporting the cryogen. Therefore, the storage container can also be referred to as a transport container. The storage container is at least double-walled and can therefore also be referred to as a double-walled storage container. The cryogen can be liquid hydrogen. The term “cryogen” is therefore interchangeable with the term “hydrogen.” However, the cryogen can also be liquid helium, liquid nitrogen, liquid oxygen, argon, neon or the like. Since the storage container is preferably suitable for receiving liquid hydrogen, it can also be referred to as a hydrogen storage container or a hydrogen storage tank. The storage container can be part of a vehicle, in particular a watercraft. In this case, the storage container is suitable for mobile applications. However, the storage container is also suitable for stationary use, for example in building technology.

The storage container is preferably rotationally symmetrical with respect to a center axis or an axis of symmetry. Accordingly, the inner container and the outer container are also rotationally symmetrical with respect to the axis of symmetry. The storage container is preferably arranged such that the axis of symmetry is perpendicular to a direction of gravity. This means that the storage container is arranged horizontally. However, the storage container may also be arranged vertically. In this case, the axis of symmetry is oriented parallel to the direction of gravity.

The inner container and the outer container are preferably both cylindrical. The inner container and the outer container each have a cylindrical base portion which is rotationally symmetrical with respect to the axis of symmetry. Both the base portion of the inner container and the base portion of the outer container are connected at the ends with two outwardly domed cover portions. However, this is not necessarily the case. The cover portions can also be designed differently. In particular, the inner container is arranged completely within the outer container, so that the outer container completely or partially envelops or wraps around the inner container. The inner container can also be referred to as an inner tank. The outer container can also be referred to as an outer tank.

The reinforcing rings are in particular part of the outer container. As previously stated, the outer container has a base portion on which the reinforcing rings are preferably provided. The reinforcing rings can also be referred to as stiffening rings. Accordingly, the term “reinforcing ring” can be arbitrarily interchanged with the term “stiffening ring.” The reinforcing rings are particularly suitable for stiffening the outer container. In this context, “stiffness” is generally to be understood to mean the resistance of a body to deformation imposed by external loads and conveys the connection between the load on the body and its deformation. The stiffness is determined by the material of the body and its geometry. By means of the reinforcing rings, buckling or denting of the outer container can be prevented.

When viewed along the axis of symmetry, the reinforcing rings are spaced apart and arranged next to one another. The number of reinforcing rings is arbitrary. The support element is provided between two neighboring reinforcing rings. The support element has a cylindrical geometry that is rotationally symmetrical to the axis of symmetry. The gap provided between the two neighboring reinforcing rings extends along a radial direction of the storage container. The radial direction is oriented perpendicular to the axis of symmetry and away therefrom.

Preferably, the support element completely fills the gap between the two neighboring reinforcing rings. The reinforcing rings are supported on the support element. Two neighboring reinforcing rings are thus indirectly supported on one another via the support element. The fact that the reinforcing rings are “supported” by the support element means in particular that the support element absorbs forces from the reinforcing rings. In particular, forces acting on the reinforcing rings are absorbed by the support element and introduced into the outer container. However, the support element can also transfer forces directly to the outer container.

In this case, a “composite material” is a material that has a matrix, for example a plastics material, in which a filler, for example in the form of fibers, is embedded. The plastics material can be a thermoplastic or a thermosetting material, such as an epoxy resin. The fibers can be long fibers or short fibers. In this case, a “short fiber” may be understood to mean a fiber with a fiber length of less than 5 mm. Accordingly, a “long fiber” is understood to mean a fiber with a fiber length of more than 5 mm. The fibers can be glass fibers, carbon fibers, aramid fibers, natural fibers or the like. The reinforcing rings may also be made of a composite material.

In accordance with one embodiment, the inner container is arranged within the reinforcing rings.

The reinforcing rings are in particular annular or disc-shaped and comprise a cylindrical outer surface and a cylindrical inner surface. The outer surface and the inner surface are each rotationally symmetrical with respect to the axis of symmetry. The inner container is passed through the reinforcing rings. This means in particular that the reinforcing rings completely run around or enclose the inner container. The reinforcing rings can also only partially or incompletely run around or enclose the inner container.

In accordance with a further embodiment, the inner container is arranged within the support element.

As previously stated, the support element has a cylindrical or tubular geometry which surrounds or encloses the inner container. The support element thus surrounds or wraps around the inner container.

In accordance with a further embodiment, the outer container envelops the support element or the support element envelops the outer container.

In the former case, the support element is attached to the inside of the outer container. In the latter case, the support element is attached to the outside of the outer container. However, the outer container may also have a support element that is attached to the inside and an additional support element that is attached to the outside.

In accordance with a further embodiment, the reinforcing rings and the support element are attached to the inside of the outer container.

In this case, the reinforcing rings are connected to a cylindrical inner surface of the outer container by means of their cylindrical outer surface.

In accordance with a further embodiment, the outer container has an inner surface facing the inner container, wherein the reinforcing rings and the support element are at least in some portions materially connected to the inner surface.

In material connections, the connection partners are held together by atomic or molecular forces. Material connections are non-releasable connections that can only be separated by destroying the connecting means and/or the connection partners. A material connection can be effected, for example, by adhesive bonding, soldering, or welding. In this case, the support element can, for example, be adhesively bonded to the inner surface of the outer container. The reinforcing rings can be soldered, welded and/or adhesively bonded to the inner surface of the outer container. The support element and the reinforcing rings are also materially connected to one another. In particular, the support element is adhesively bonded to the reinforcing rings.

In accordance with a further embodiment, the reinforcing rings and the support element are attached to the outside of the outer container.

The reinforcing rings and the support element are in particular connected to an outer surface of the outer container. In addition, reinforcing rings and a corresponding support element can also be provided on the inside of the outer container.

In accordance with a further embodiment, the outer container has an outer surface facing away from the inner container, wherein the reinforcing rings and the support element are materially connected to the outer surface.

The reinforcing rings have a cylindrical inner surface as stated above, which is materially connected to the outer surface of the outer container.

In accordance with a further embodiment, a gap subjected to a vacuum is provided between the inner container and the outer container, wherein the reinforcing rings and the support element are arranged within the gap.

Alternatively, the reinforcing rings and the support element may also be arranged outside the gap. In this case, the reinforcing rings and the support element are not provided on the inside of the outer container, but on the outside of the outer container. In the present case, a “vacuum” is understood to mean a pressure of less than 300 mbar, preferably less than 10⁻³ mbar, more preferably less than 10⁻⁷ mbar. The storage container is thus vacuum-insulated. The gap extends in particular along the radial direction.

In accordance with a further embodiment, an insulation element enveloping the inner container is arranged in the gap.

Preferably, the insulation element does not completely fill the gap. A further gap may be provided between the insulation element and the support element, which is part of the aforementioned gap. This additional gap is optional. The insulation element and the support element may also completely fill the gap provided between the inner container and the outer container. The insulation element serves for thermal insulation. The insulation element is multi-layered. This means that the insulation element comprises a plurality of layers. The insulation element can therefore also be referred to as a multi-layer insulation element or a multi-layer thermal insulation element. In particular, the insulation element is a so-called multi-layer insulation (MLI). In this case, the insulation element comprises a plurality of alternately arranged layers of perforated and/or embossed aluminum foil as a reflector and glass paper as spacers between neighboring aluminum foils. Instead of the multi-layered structure explained above, the insulation element may also have a filling of perlite or the like.

In accordance with a further embodiment, the composite material is long-fiber reinforced or short-fiber reinforced.

A combination of short fibers and long fibers may also be provided. The fibers can be chosen arbitrarily. For example, glass fibers, carbon fibers, aramid fibers, natural fibers or the like are used. Instead of fibers, the composite material may comprise any other fillers, such as cotton flakes, microspheres or the like.

In accordance with a further embodiment, the composite material is a laminate or a casting compound.

For example, the composite material can be wound or laminated onto the outer container. In this case, the composite material is a multi-layer laminate with fibers, fiber fabrics, fiber layups or fiber mats embedded in the matrix of the composite material. Alternatively, the composite material may also be castable or sprayable. In this case, the composite material is preferably short-fiber reinforced.

In accordance with a further embodiment, the reinforcing rings are made of an aluminum alloy or a composite material.

This can result in weight savings. The composite material may be a fiber-reinforced composite material. However, the reinforcing rings can also be made of stainless steel, for example. In principle, any other metals can be used.

In accordance with a further embodiment, the inner container and/or the outer container are made of stainless steel.

Alternatively, for example, the outer container can be made at least partially of a composite material. The inner container may also comprise a composite material.

In accordance with a further embodiment, the outer container has a cylindrical base portion to which the reinforcing rings are attached.

The reinforcing rings are materially connected to the base portion. As previously stated, the base portion is closed at the front by two cover portions that are domed away from one another. However, this is not mandatory. The reinforcing rings are preferably only attached to the base portion.

In the present case, “a(n)” is not necessarily to be understood as limiting to exactly one element. It is rather the case that multiple elements, such as two, three, or more, may also be provided. Any other numerical word used herein is also not to be understood as meaning an exact limitation to exactly the corresponding number of elements. Rather, numerical differences upwards or downwards are possible.

Further possible implementations of the storage container also include not explicitly mentioned combinations of features or embodiments described above or below with respect to the embodiments. A person skilled in the art will also add individual aspects as improvements or additions to the respective basic form of the storage container.

Further advantageous embodiments of the storage container are the subject-matter of the dependent claims and of the embodiments of the storage container described below. The storage container is explained below in more detail on the basis of preferred embodiments while making reference to the provided figures.

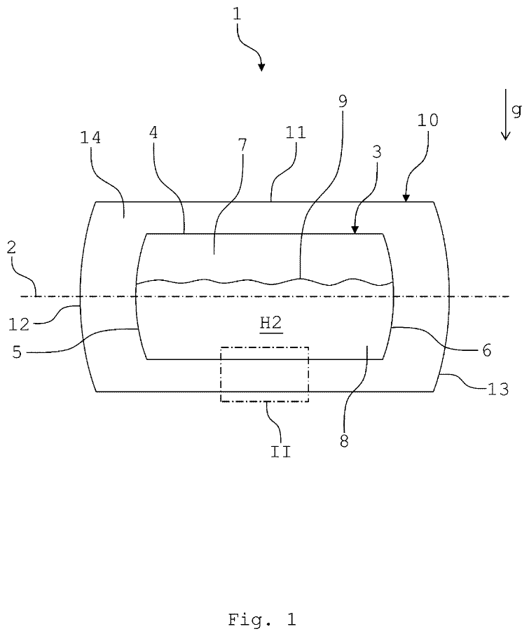

FIG. 1 shows a schematic sectional view of an embodiment of a storage container;

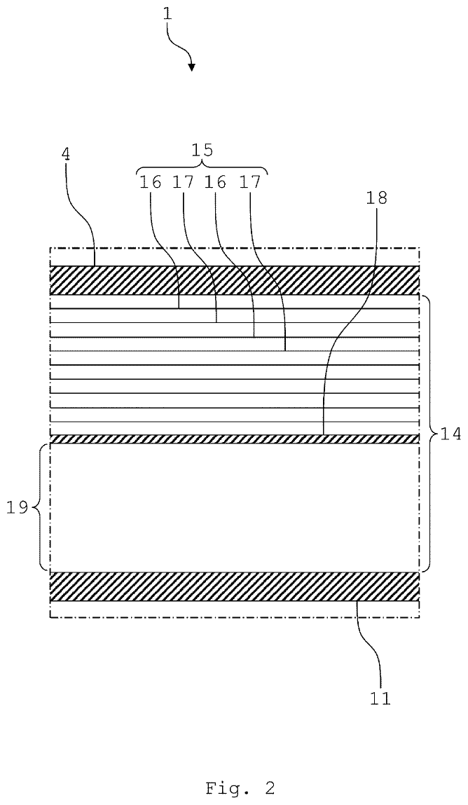

FIG. 2 shows the detailed view II in accordance with FIG. 1;

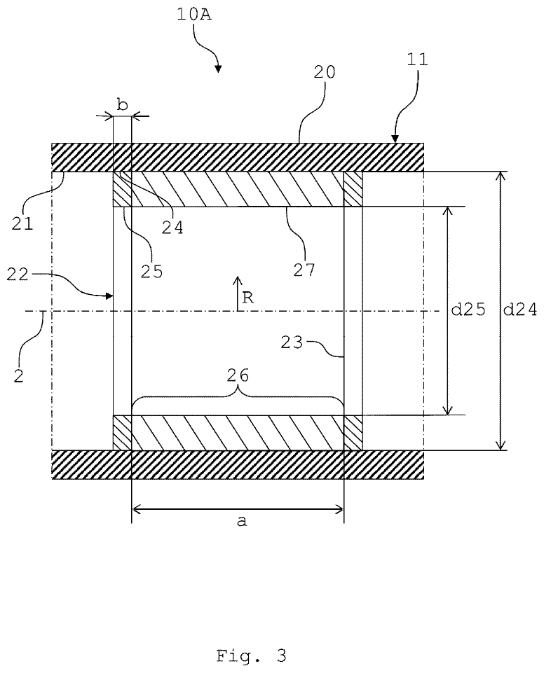

FIG. 3 shows a schematic sectional view of an embodiment of an outer container for the storage container in accordance with FIG. 1; and

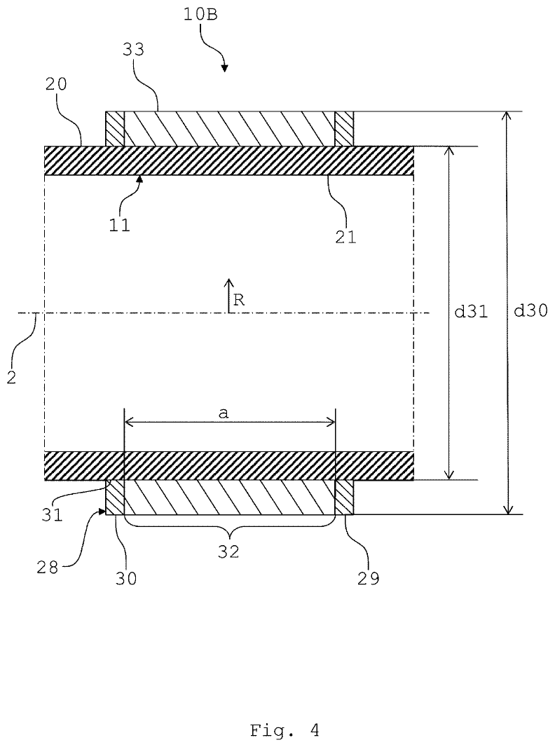

FIG. 4 shows a schematic sectional view of a further embodiment of an outer container for the storage container in accordance with FIG. 1.

In the figures, the same or functionally equivalent elements have been provided with the same reference signs unless otherwise indicated.

FIG. 1 shows a schematic sectional view of an embodiment of a storage container 1. FIG. 2 shows the detailed view II in accordance with FIG. 1. In the following, reference is made simultaneously to FIGS. 1 and 2.

The storage container 1 can also be referred to as a storage tank. The storage container 1 is preferably suitable for receiving liquid hydrogen H2 (boiling point 1 bara: 20.268 K=−252.882° C.). The storage container 1 can therefore also be referred to as a hydrogen storage container or as a hydrogen storage tank. However, the storage container 1 can also be used for other cryogenic liquids. Examples of cryogenic fluids or liquids, or cryogens for short, are, in addition to the aforementioned hydrogen H2, liquid helium He (boiling point 1 bara: 4.222 K =−268.928° C.), liquid nitrogen N2 (boiling point 1 bara: 77.35 K=−195.80° C.) or liquid oxygen O2 (boiling point: 1 bara: 90.18 K=−182.97° C.).

The storage container 1 can be a transport container. For example, liquid hydrogen H2 can be transported using the storage container 1. The storage container 1 can be part of a vehicle, in particular a watercraft. In this case, the storage container 1 is suitable for mobile applications. However, the storage container 1 is also suitable for stationary use, for example in building technology.

The storage container 1 is rotationally symmetrical with respect to a center axis or an axis of symmetry 2. The axis of symmetry 2 is oriented perpendicular to a direction of gravity g. The storage container 1 comprises a first container or inner container 3, which is also rotationally symmetrical with respect to the axis of symmetry 2. The inner container 3 comprises a tubular or cylindrical base portion 4, which is also rotationally symmetrical with respect to the axis of symmetry 2. In cross portion, the base portion 4 can have a circular or approximately circular geometry.

The base portion 4 is closed on both sides at the front with the aid of a cover portion 5, 6. The cover portions 5, 6 are domed. A first cover portion 5 and a second cover portion 6 are domed in opposite directions, so that the cover portions 5, 6 are domed outward in relation to the base portion 4. The inner container 3 is fluid-tight, in particular gas-tight. The inner container 3 is made of stainless steel.

The liquid hydrogen H2 is received in the inner container 3. As long as the hydrogen H2 is in the two-phase region, a gas zone 7 with vaporized hydrogen H2 and a liquid zone 8 with liquid hydrogen H2 can be provided in the inner container 3. After entering the inner container 3, the hydrogen H2 thus has two phases with different aggregate states, namely, liquid and gaseous. This means that in the inner container 3 there is a phase boundary 9 between the liquid hydrogen H2 and the gaseous hydrogen H2.

The inner container 3 is arranged completely within a second container or outer container 10. The storage container 1 is therefore double-walled. The outer container 10 is also rotationally symmetrically with respect to the axis of symmetry 2. The outer container 10, like the inner container 3, comprises a tubular or cylindrical base portion 11 which is rotationally symmetrical with respect to the axis of symmetry 2. In cross portion, the base portion 11 can have a circular or approximately circular geometry.

The base portion 11 is closed at the front by a cover portion 12, 13. In particular, a first cover portion 12 and a second cover portion 13 are provided. The cover portions 12, 13 are domed in opposite directions so that the cover portions 12, 13 are domed outward in relation to the base portion 11. The outer container 10 is fluid-tight, in particular gas-tight. The outer container 10 is also made of stainless steel.

Between the inner container 3 and the outer container 10, a gap 14 is provided which completely wraps around or envelops the inner container 3. The gap 14 is subjected to a vacuum. In the present case, a “vacuum” is understood to mean a pressure of less than 300 mbar, preferably less than 10⁻³ mbar, more preferably less than 10⁻⁷ mbar. The storage container 1 is thus vacuum-insulated. The fact that the gap 14 completely “wraps around” or “envelops” the inner container 3 means in the present case that the gap 14, runs completely around the base portion 4 and is also provided between the two cover portions 5, 12 and between the two cover portions 6, 13.

A thermal insulation element or insulation element 15 (FIG. 2) which completely envelops or encloses the inner container 3 is provided in the gap 14. This means that the insulation element 15 encloses both the base portion 4 and the cover portions 5, 6 of the inner container 3. The insulation element 15 serves for thermal insulation. The insulation element 15 is multi-layered. This means that the insulation element 15 comprises a plurality of layers. The insulation element 15 can therefore also be referred to as a multi-layer insulation element or a multi-layer thermal insulation element.

In particular, the insulation element 15 is a so-called multi-layer insulation (MLI). The insulation element 15 comprises a plurality of alternately arranged layers of perforated and/or embossed aluminum foil 16 as a reflector and glass paper 17 as spacers between neighboring aluminum foils 16. The glass paper 17 can be perforated and/or punched. In FIG. 2, only two layers of aluminum foil 16 and two layers of glass paper 17 are provided with a reference sign. The glass paper 17 acts as a spacer between two neighboring aluminum foils 16, which allows the insulation element 15 to be exposed to the vacuum prevailing in the gap 14. The insulation element 15 only partially fills the gap 14. The insulation element 15 rests on the outside of the inner container 3.

The insulation element 15 is assigned a metal foil 18, which closes off the insulation element 15 in the direction of the outer container 10. The metal foil 18 completely encloses or wraps around the insulation element 15 or the inner container 3. The metal foil 18 can be, for example, an aluminum foil or a copper foil. In comparison with the aluminum foil 16, the metal foil 18 has a greater thickness or wall thickness. The metal foil 18 is optional. The metal foil 18 can be part of the insulation element 15. The metal foil 18 is preferably not fluid-tight and thus fluid-permeable so that the insulation element 15 can be evacuated.

A gap 19 that completely wraps around or envelops the insulation element 15 is provided between the insulation element 15 or between the metal foil 18 and the outer container 10. The gap 19 is in particular part of the gap 14. The gap 19 can, for example, have a gap width of 100 mm. The gap 19 can be filled with a filling of perlite or the like. As an alternative to perlite, however, rock wool, glass wool or any other suitable insulating material may also be used. The insulation element 15 can also have a filling of perlite or the like instead of the multi-layered structure explained above.

FIG. 3 is a schematic sectional view of an embodiment of an outer container 10A for the storage container 1.

In particular, only the base portion 11 of the outer container 10A is shown in FIG. 3. The base portion 11 comprises a cylindrical outer surface 20, which is rotationally symmetrical with respect to the axis of symmetry 2, and a cylindrical inner surface 21, which is also rotationally symmetrical with respect to the axis of symmetry 2. The outer surface 20 faces away from the inner container 3, not shown). The inner surface 21 faces the inner container 3. When viewed along a radial direction R which is oriented perpendicular to the axis of symmetry 2 and away therefrom, the inner surface 21 is placed within the outer surface 20.

The base portion 11 can be made of a steel alloy, in particular stainless steel or carbon steel. The base portion 11 is tubular. The base portion 11 is rotationally symmetrically with respect to the axis of symmetry 2. To form the outer container 10A, the base portion 11 is closed off at the front by means of the cover portions 12, 13 (not shown). The cover portions 12, 13 are materially connected to the base portion 11. In material connections, the connection partners are held together by atomic or molecular forces. Material connections are non-releasable connections that can only be separated by destroying the connecting means and/or the connection partners. A material connection can be effected, for example, by adhesive bonding, soldering, or welding.

Multiple reinforcing rings 22, 23 are attached to the base portion 11. The number of reinforcing rings 22, 23 is arbitrary. In FIG. 3, exactly two reinforcing rings 22, 23 are shown. The reinforcing rings 22, 23 can be of identical construction. When viewed along the axis of symmetry 2, the reinforcing rings 22, 23 are spaced apart from one another by a distance a. Each reinforcing ring 22, 23 is rotationally symmetrical with respect to the axis of symmetry 2. The reinforcing rings 22, 23 can be made of a steel alloy or of a fiber composite material.

Each reinforcing ring 22, 23 has a cylindrical outer surface 24 which is rotationally symmetrical with respect to the axis of symmetry 2 and a cylindrical inner surface 25 which is also rotationally symmetrical with respect to the axis of symmetry 2. When viewed along the radial direction R, the inner surface 25 is arranged within the outer surface 24. The inner container 3 is placed within the reinforcing rings 22, 23. This means in particular that the inner container 3 is passed through the reinforcing rings 22, 23. On the outer surface 24, the reinforcing rings 22, 23 each have a diameter d24. On the inner surface 25, the reinforcing rings 22, 23 each have a diameter d25. The diameter d24 is larger than the diameter d25.

The reinforcing rings 22, 23 are connected with their outer surfaces 24 to the inner surface 21 of the base portion 11. A material connection is provided for this purpose. For example, the reinforcing rings 22, 23 are adhesively bonded, soldered and/or welded to the inner surface 21 on their outer surfaces 24. The reinforcing rings 22, 23 are thus placed within the base portion 11. Each reinforcing ring 22, 23 has a width b when viewed along the axis of symmetry 2. Between two neighboring reinforcing rings 22, 23, a gap 26 is provided along the axis of symmetry 2, which spaces the reinforcing rings 22, 23 apart from one another by the distance a.

The gap 26 is at least partially filled with a support element 27. The reinforcing rings 22, 23 can support one another via the support element 27. The support element 27 forms a hollow cylindrical geometry which is rotationally symmetrical to the axis of symmetry 2. The support element 27 contacts the inner surface 21 of the base portion 11 and is materially connected thereto, for example adhesively bonded. The inner container 3 is placed within the cylindrical support element 27.

The support element 27 is made of a composite material. In the present case, a “composite material” is understood to mean a material that has a matrix, for example a plastics material, in which filler, for example in the form of fibers, is embedded. The plastics material can be a thermoplastic or an elastomer, such as an epoxy resin. The fibers can be long fibers or short fibers. The fibers can be glass fibers, carbon fibers, aramid fibers, natural fibers or the like. In addition to fibers, any other filler may be used. The support element 27 can be a multi-layered laminate with fibers, fiber fabrics, fiber layups or fiber mats embedded in the matrix. The composite material may also be castable or sprayable. In this case, the composite material is preferably short-fiber reinforced.

In comparison with the reinforcing rings 22, 23, the support element 27 has a reduced density. When viewed opposite to the radial direction R, the support element 27 does not protrude beyond the inner surface 25. Due to the fact that the support element 27 is arranged between the reinforcing rings 22, 23, it is possible for the reinforcing rings 22, 23 to support one another via the support element 27. The distance a between the reinforcing rings 22, 23 can thus be increased and/or the reinforcing rings 22, 23 can be made smaller. This means, for example, that the width b of the reinforcing rings 22, 23 can be reduced.

By using the support element 27, a weight of the outer container 10A and thus of the storage container 1 itself can be reduced. Since, in particular for transporting the storage container 1 filled with hydrogen H2, its total weight must not exceed a predetermined value, it is advantageous if the empty weight of the storage container 1 is as low as possible, so that a larger amount of hydrogen H2 can be transported compared with a storage container (not shown) with a higher empty weight.

FIG. 4 is a schematic sectional view of a further embodiment of an outer container 10B for the storage container 1.

The structure of the outer container 10B substantially corresponds to that of the outer container 10A. In contrast to the outer container 10A, the outer container 10B does not have internal reinforcing rings 22, 23, but external reinforcing rings 28, 29. Each reinforcing ring 28, 29 has a cylindrical outer surface 30 and a cylindrical inner surface 31. The outer surface 30 has a diameter d30. The inner surface 31 has a diameter d31. The diameter d30 is larger than the diameter d31.

On the inner surfaces 31, the reinforcing rings 28, 29 are materially connected to the outer surface 20. A gap 32 is provided between each two neighboring reinforcing rings 28, 29, which gap keeps the reinforcing rings 28, 29 spaced apart from one another by a distance a as previously stated. The gap 32 is filled with a support element 33, which is also made of a composite material. In contrast to the support element 27, the support element 33 is not attached to the inside but to the outside of the outer container 10B. This means that the support element 33 contacts the outer container 10B on the outer surface 20. The support element 33 is adhesively bonded to the outer surface 20.

Although the present invention has been described with reference to embodiments, it can be modified in many ways within the scope of the claims.

### REFERENCE SIGNS USED

1 Storage container
2 Axis of symmetry
3 Inner container
4 Base portion
5 Cover portion
6 Cover portion
7 Gas zone
8 Liquid zone
9 Phase boundary
10 Outer container
10A Outer container
10B Outer container
11 Base portion
12 Cover portion
13 Cover portion
14 Gap
15 Insulation element
16 Aluminum foil
17 Glass paper
18 Metal foil
19 Gap
20 Outer surface
21 Inner surface
22 Reinforcing ring
23 Reinforcing ring
24 Outer surface
25 Inner surface
26 Gap
27 Support element
28 Reinforcing ring
29 Reinforcing ring
30 Outer surface
31 Inner surface
32 Gap
33 Support element
a Distance
b Width
d24 Diameter
d25 Diameter
d30 Diameter
d31 Diameter
g Direction of gravity
H2 Cryogen/Hydrogen

1. A storage container for storing a cryogen, comprising an inner container for receiving the cryogen and an outer container in which the inner container is accommodated, wherein the outer container has reinforcing rings for reinforcing the outer container and the outer container has a support element which is made of a composite material and of which at least some portions are arranged within a gap between two neighboring reinforcing rings, in order to support the reinforcing rings.

2. The storage container according to claim 1, wherein the inner container is arranged within the reinforcing rings.

3. The storage container according to claim 1, wherein the inner container is arranged within the support element.

4. The storage container according to claim 1, wherein the outer container envelops the support element, or wherein the support element envelops the outer container.

5. The storage container according to claim 1, wherein the reinforcing rings and the support element are attached to the inside of the outer container.

6. The storage container according to claim 5, wherein the outer container has an inner surface facing the inner container, and wherein the reinforcing rings and the support element are at least partially materially connected to the inner surface.

7. The storage container according to claim 1, wherein the reinforcing rings and the support element are attached to the outside of the outer container.

8. The storage container according to claim 7, wherein the outer container has an outer surface facing away from the inner container, and wherein the reinforcing rings and the support element are materially connected to the outer surface.

9. The storage container according to claim 1, wherein a gap subjected to a vacuum is provided between the inner container and the outer container, wherein the reinforcing rings and the support element are arranged within the gap.

10. The storage container according to claim 9, wherein an insulating element enveloping the inner container is arranged in the gap.

11. The storage container according to claim 1, wherein the composite material is long-fiber reinforced or short-fiber reinforced.

12. The storage container according to claim 1, wherein the composite material is a laminate or a casting compound.

13. The storage container according to claim 1, wherein the reinforcing rings are made of an aluminum alloy or a composite material.

14. The storage container according to claim 1, wherein the inner container and/or the outer container are made of stainless steel.

15. The storage container according to claim 1, wherein the outer container has a cylindrical base portion to which the reinforcing rings are attached.
